(19) United States
(12) Patent Application Publication
(10) Pub. No.: US 2026/0185457 A1
(43) Pub. Date: Jul. 2, 2026

(54) TURBOMACHINE COMPRISING AN ELECTRIC MACHINE PROVIDED WITH A FIXED WINDING, AN EXCITATION WINDING AND A ROTARY WINDING WHICH ARE ARRANGED RADIALLY

(71) Applicant: SAFRAN AIRCRAFT ENGINES, PARIS (FR)

(72) Inventors: Irène BUJON, MOISSY-CRAMAYEL (FR); Adrian FLORESCU, MOISSY-CRAMAYEL (FR)

(73) Assignee: SAFRAN AIRCRAFT ENGINES, PARIS (FR)

(21) Appl. No.: 19/548,477

(22) Filed: Feb. 24, 2026

Related U.S. Application Data
(63) Continuation of application No. PCT/FR2024/050996, filed on Jul. 18, 2024.

(30) Foreign Application Priority Data
Aug. 29, 2023 (FR) 23/09054

(51) Int. Cl. F01D 15/10; B64D 27/10; F01D 7/00; F01D 25/02; H02K 7/18

(52) U.S. Cl. CPC F01D 15/10; B64D 27/10; F01D 7/00; F01D 25/02; H02K 7/1823; F05D 2220/76

(57) ABSTRACT

A turbomachine for an aircraft includes one part rotating about an axis of rotation and one part fixed in rotation about the axis of rotation relative to the rotating part. The fixed part includes a fan casing and one electric machine that operates in generator mode. The electric machine includes at least one fixed winding and one excitation winding, which are positioned on the fixed part of the turbomachine, and at least one rotating winding positioned on the rotating part of the turbomachine. The fixed winding, the excitation winding and the rotating winding are arranged radially about the axis of rotation.

### CROSS-REFERENCE TO RELATED APPLICATIONS

This application is a continuation of International Application No. PCT/FR2024/050996, filed on Jul. 18, 2024, which claims priority to and the benefit of FR 23/09054 filed on Aug. 29, 2023. The disclosures of the above applications are incorporated herein by reference.

### FIELD

The present disclosure relates to aircraft turbomachines, and more particularly to a turbomachine and an aircraft comprising such a turbomachine.

### BACKGROUND

The statements in this section merely provide background information related to the present disclosure and may not constitute prior art.

In the present disclosure, the term “aircraft turbomachine” refers to a set of turbomachines or gas turbine machines that produce motive power, dedicated to aircraft propulsion and equipped with a nacelle or not. Among these machines, a distinction is made between turbojet engines which provide the thrust desired for propulsion by reaction through the high-speed ejection of gases, and turboshaft engines, in which motive power is provided by the rotation of a drive shaft. For example, turboshaft engines are used as helicopter engines. Turboprop engines (turboshaft engine driving a propeller) are turboshaft engines used as aircraft engines.

Climate change is a major concern for many legislative and regulatory bodies worldwide. Indeed, various restrictions on carbon emissions have been, are being, or will be adopted by various countries. In particular, an ambitious standard applies to both new types of aircrafts and those currently in service, requiring the implementation of technological solutions to bring them into compliance with current regulations. Civil aviation has been actively working for several years now to contribute to the fight against climate change.

Technological research efforts have already led to very significant improvements in the environmental performance of airplanes. The Applicant considered the factors impacting all phases of design and development to obtain aeronautical components and products that are less energy-intensive, more environmentally friendly, and whose integration and use in civil aviation have moderate environmental impacts, with the aim of improving the energy efficiency of aircrafts.

Consequently, the Applicant is constantly working to reduce its climate impact by using methods and operating virtuous development and manufacturing methods that reduce greenhouse gas emissions as much as possible in order to reduce the environmental footprint of its activity.

This sustained research and development work focuses on new generations of airplane engines, the weight reduction of aircraft, in particular through the materials used and lighter on-board equipment, the development of the use of electrical technologies to provide propulsion, and, as complements to technological progress, aviation biofuels.

There are devices disposed in a rotating part of a turbomachine, for example a rotor of a turbine, such as a device for controlling a pitch of the blades of a fan, fan blade small-pitch protection devices, de-icing devices for a cone or the fan blades, etc. Such devices can be powered by electrical energy.

To achieve this, it is known to have an electric machine in a fixed part of a turbomachine and to transmit electrical energy to the rotating part. This can be accomplished, for example, using a slip ring. However, such a slip ring can be fragile and require regular maintenance operations.

The fixed part refers to devices of the turbomachine configured to be stationary or fixed in rotation relative to an aircraft on which the turbomachine is installed. The fixed part comprises, for example, the fan casing.

The rotating part refers to devices of the turbomachine configured to be movable in rotation relative to the aircraft on which the turbomachine is installed.

Electrical energy can also be transmitted to the rotating part by a rotating transformer associated with an inverter, resulting in an increase in the mass and volume of the turbomachine. Furthermore, an electromagnetic field generated by the rotating transformer can interfere with measurement devices of the turbomachine, such as a speed sensor or a fan pitch setting sensor.

### SUMMARY

This section provides a general summary of the disclosure and is not a comprehensive disclosure of its full scope or all of its features.

One variation concerns a turbomachine for an aircraft, the turbomachine extending along an axis of rotation and comprising at least: one part rotating about the axis of rotation, one part fixed in rotation about the axis of rotation relative to the rotating part, the fixed part comprising a fan casing, one electric machine adapted to operate in generator mode, the turbomachine being characterized in that the electric machine comprises at least one fixed winding and one excitation winding, which are positioned on the fixed part of the turbomachine, and at least one rotating winding positioned on the rotating part of the turbomachine, the fixed winding, the excitation winding and the rotating winding being arranged radially about the axis of rotation.

Generally, the axial direction corresponds to the direction of the axis of rotation of the turbomachine (or of a disk of a fan), and a radial direction is a direction perpendicular to the axis of rotation.

Furthermore, upstream and downstream are defined with respect to a normal flow direction of gases (upstream to downstream) through the turbomachine.

In some variations, the turbomachine comprises at least one turbine, at least one compressor and at least one fan which are positioned along the axial direction, i.e. linearly along the axis of rotation.

The turbomachine may also comprise a nacelle.

The turbine, compressor, and nacelle comprise elements or devices that form the fixed part of the turbomachine relative to the aircraft, when the turbomachine is fastened to the aircraft via the nacelle. In other words, the fixed part is secured to the nacelle.

The turbine, compressor, and fan comprise elements movable in rotation about the axis of rotation. These elements form the rotating part of the turbomachine. These elements have a relative movement with respect to the nacelle.

By means of gas expansion in a combustion chamber, the turbomachine drives in rotation the axis of rotation on which the rotating part is fastened.

The turbomachine also comprises at least one electric machine according to the present disclosure. The electric machine can be used in generator mode in which it produces electrical energy, or in motor mode in which it consumes energy in order to rotate the axis of rotation.

More specifically, the electric machine is a rotating machine that can convert mechanical energy into alternating current electrical energy and vice versa.

Generally, a winding can refer to an electrical coil.

The machine according to the present disclosure comprises at least one fixed winding and one excitation winding, both of which are positioned on the fixed part of the turbomachine.

The machine also comprises at least one rotating winding positioned on the rotating part of the turbomachine.

The fixed winding, the excitation winding and the rotating winding are arranged radially about the axis of rotation.

The fixed winding, the excitation winding and the rotating winding are positioned concentrically about the axis of rotation so that electrical inductions are possible between each of the windings.

When the electric machine is operating in the motor mode, the fixed winding is an inductor of the machine, i.e., its function is to induce an electromagnetic field in the rotating winding positioned on the rotating part. To achieve this, the fixed winding is electrically powered, in particular by a three-phase current. An electromagnetic field created by the fixed winding induces an electromagnetic field in the rotating winding, thereby driving in rotation the rotating part. The rotating winding is therefore an armature of the electric machine.

The motor mode of the electric machine can be used when starting the turbomachine, or during a maintenance operation requiring a rotation of the rotating part of the turbomachine, or even to inject mechanical torque onto a shaft of the turbomachine to which the electric machine is coupled during any flight phase of the aircraft.

When the machine is operating in a generator mode, the rotating winding is both an armature and an inductor of the machine. Indeed, on the one hand, it is excited by the excitation winding so that it produces a three-phase electric current in the rotating part, and on the other hand, it induces an electromagnetic field in the fixed winding positioned on the fixed part, so that the fixed winding generates a three-phase electric current in the fixed part. The rotating winding delivers a variable voltage whose effective value and frequency vary with a supply voltage of the excitation winding.

The electric current generated by the fixed winding or the rotating winding is a sinusoidal alternating current.

The electric machine therefore has several functions depending on whether it operates in motor mode or generator mode.

The present disclosure may also include one or more of the following features, taken alone or in combination.

According to one variation, the turbomachine can comprise, on the one hand, a high-pressure spool including a high-pressure compressor and a high-pressure turbine, and on the other hand, a low-pressure spool including a low-pressure compressor and a low-pressure turbine.

According to one variation, the turbomachine also comprises an intermediate spool including an intermediate pressure compressor and an intermediate pressure turbine.

According to one variation, the electric machine is positioned between the fan and the compressor.

According to one variation, the electric machine is positioned between the fan and a reduction gear box.

According to one variation, the electric machine is positioned between a reduction gear box and the compressor.

Thus, the electric machine has a higher operating speed and therefore better efficiency.

According to one variation, the rotating winding is positioned on a low-pressure shaft of the turbomachine.

According to one variation, the turbomachine comprises at least one electrical power network positioned in the rotating part, the at least one electrical power network being connected to the at least one rotating winding, and configured to circulate an electric current with a power greater than or equal to 10 kW and less than or equal to 50 kW.

The electric machine, and more particularly the rotating winding, is sized to provide the electric power current to the electrical power network which is positioned in the rotating part.

The electric power current is generated directly in the rotating part by the electric machine.

According to one variation, at least one electrical power network is configured to power at least one electrical device of the turbomachine which is positioned on the rotating part.

The present disclosure generates an electric current in the rotating part in order to power functions, also called electrical devices, of the turbomachine located in the rotating part. This eliminates the to cause current to pass from the fixed part to the rotating part. The efficiency, weight, and volume of the turbomachine are thus improved.

An electrical device is any element of the turbomachine that consumes electricity. The electrically implemented functions of the turbomachine can also be called “electrical loads”. A device can carry out a physical action on the turbomachine, such as heating, or a regulation or control action.

However, although the present disclosure generates an electric current in the rotating part, the electric machine according to the present disclosure also generates an electric current in the fixed part, as detailed above. The electric current generated in the fixed part is intended to power electrical elements positioned in the fixed part.

According to one variation, the at least one electrical device of the turbomachine positioned in the rotating part is a device for controlling a pitch of the blades of a fan, fan blade small-pitch protection devices, de-icing devices for a cone or the fan blades.

For example, de-icing a cone or the fan blades requires an electric power of approximately 30 kW.

According to one variation, the electric machine is a wound-rotor machine.

According to one variation, the fixed winding and the excitation winding are electrically connected so that an electric supply current generated by the fixed winding can power the excitation winding.

In the generator mode, the rotating winding induces an electromagnetic field in the fixed winding positioned on the fixed part so that the fixed winding generates a three-phase electric current in the fixed part. This electric current can then power the excitation winding of the electric machine. This is known as self-powering. The frequency of the voltage of the electric current generated by the fixed winding then depends on a rotational speed of the rotating part.

According to one variation, the fixed winding is electrically connected to a general electrical network positioned on the fixed part.

The general electrical network corresponds to an electrical network of the turbomachine, and more generally of the aircraft, which powers devices in the fixed part such as a power supply for the flight controls, wing anti-icing, a power supply for the cabin air conditioning system, lighting of an aircraft cabin, or even a power supply for the cockpit.

This makes it possible to provide redundancy of electrical power supply on the general electrical network.

According to one variation, the excitation winding comprises a DC/DC converter or a DC/AC converter.

According to one variation, the turbomachine comprising a mechanical element for separating and disconnecting the electric machine from a shaft of the turbomachine.

Indeed, in the event of an electrical failure of the electric machine or the electrical power network, it is desirable to have an element that allows the electric machine to be mechanically disconnected.

According to one variation, the at least one electric machine is positioned inside the fan casing.

According to one variation, the mechanical separation element can be a dog clutch.

Another aspect of the present disclosure relates to an aircraft comprising a turbomachine according to any one of the variations of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a representation of an aircraft;

FIG. 2 is a schematic representation of an architecture of a turbomachine based on an example of the present disclosure;

FIG. 3 illustrates one variation of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

FIG. 1 represents an aircraft 100, in this example an airplane equipped with two turbomachines 50, in this example two propulsion units or two turbojet engines 50, namely one turbomachine 50 per wing 101. Only one turbomachine 50 and one wing 101 are represented in FIG. 1. According to one variant, the aircraft 100 can be equipped with more than one turbomachine 50 per wing 101, each wing 101 being provided with the same number of turbomachines 50.

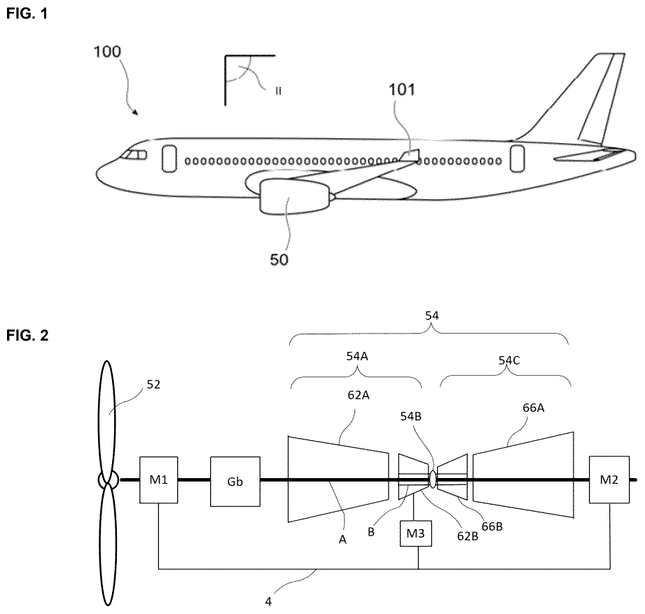

FIG. 2 represents a schematic view, in cross-section along plane II of FIG. 1, of an architecture of the turbomachine 50 according to the present disclosure.

The turbomachine 50 comprises a fan 52, which is positioned in a fan casing and a gas generator 54.

In this example, the gas generator 54 comprises, from upstream to downstream, the gases flowing within the turbomachine 50 from upstream to downstream, a compressor 54A (or compressor section 54A), a combustion chamber 54B, and a turbine 54C (or turbine section 54C).

The fan 52 can be driven in rotation by a shaft of the gas generator 54, for example directly by a shaft A of a low-pressure spool, or via a reduction gear box Gb, also called RGB, mechanically coupled to the shaft A of the low-pressure spool. The reduction gear box Gb makes it possible to reduce the rotational speed of the fan 52 relative to that of the shaft A of the low-pressure spool.

The gas generator 54 can be of the twin-spool type and can comprise a low-pressure spool and a high-pressure spool.

The low-pressure spool may comprise a low-pressure compressor 62A coupled in rotation with a low-pressure turbine 66A via a low-pressure shaft A.

The high-pressure spool may comprise a high-pressure compressor 62B disposed downstream of the low-pressure compressor 62A and upstream of the combustion chamber 54B, and a high-pressure turbine 66B, disposed downstream of the combustion chamber 54B and upstream of the low-pressure turbine 66A, and coupled in rotation with the high-pressure compressor 62B via a high-pressure shaft B.

The compressor 54A of the gas generator 54 may comprise the low- and high-pressure compressors 62A and 62B. The turbine 54C of the gas generator 54 may comprise the low- and high-pressure turbines 66B and 66A.

FIG. 2 is schematic, each compressor and each turbine being able to have one or several stages, each stage comprising a moving wheel and a stator.

The turbomachine 50 comprises elements movable in rotation, hereafter referred to as rotating part Pt, about an axis of rotation, in a nacelle of the turbomachine 50. The nacelle is configured to be fastened on the aircraft 100. Hereafter, the fixed part Pf refers to elements of the high-pressure spool, the low-pressure spool which are fixed relative to the nacelle.

FIG. 2 illustrates the positioning of electric machines M1, M2, M3 connected to a general electrical network 4 of the turbomachine, and more generally of the aircraft 100. The general electrical network 4 powers devices in the fixed part Pf such as a power supply for the flight controls, wing anti-icing, a power supply for the cabin air conditioning system, lighting of an aircraft cabin, or even a power supply for the cockpit.

A first electric machine M1 is positioned between the fan 52 and the compressor 54A of the gas generator 54. More specifically, the electric machine M1 is positioned axially (along the axis of rotation A) between the fan 52 and the reduction gear box Gb or alternatively positioned axially between the reduction gear box Gb and the compressor 54A.

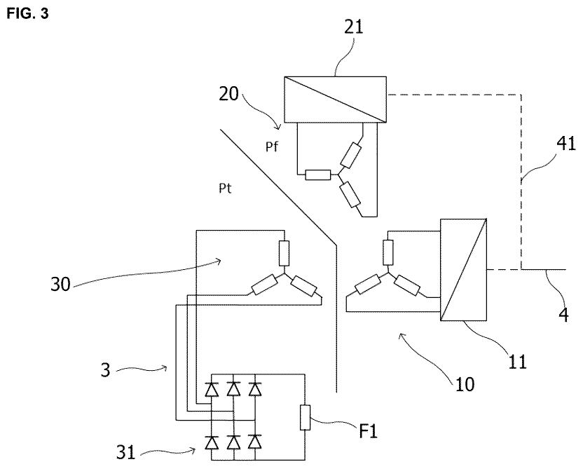

The electric machine M1 will be described in more detail with reference to FIG. 3.

A second electric machine M2 is positioned downstream of the turbine 54C and a third electric machine M3 is positioned at the high-pressure compressor 62B.

The electric machines M1, M2 and M3 produce an electric current intended to be consumed in the rotating part Pt of the turbomachine 50 or to be transmitted on the general electrical network 4.

Having several electric machines M1, M2, M3 makes it possible to reduce the size of each of the electric machines M1, M2, M3. They can therefore be more easily integrated into the overall architecture of the turbomachine. Another advantage of positioning several electric machines M1, M2, M3 is, on the one hand, to have a redundancy and therefore better overall reliability of the general electrical network 4, and on the other hand, to be able to install simple electric machines.

More particularly, a variation of the turbomachine 50 according to the present disclosure is described with reference to FIG. 3.

The turbomachine 50 comprises an electric machine M1 which comprises elements positioned on the rotating part Pt and others on the fixed part Pf of the turbomachine.

On the fixed part Pf, the electric machine M1 comprises at least one fixed winding 10 and one excitation winding 20.

The rotating part Pt of the electric machine M1 comprises at least one rotating winding 30.

The fixed winding 10, the excitation winding 20 and the rotating winding 30 are arranged radially about the axis of rotation.

The fixed winding 10, the excitation winding 20 and the rotating winding 30 are positioned concentrically about the axis of rotation so that electrical inductions are possible between each of the windings 10, 20, 30.

The fixed winding is electrically connected to the general electrical network 4 positioned on the fixed part Pf.

Furthermore, the fixed winding 10 and the excitation winding 20 are electrically connected by an electrical connection 41 so that an electric supply current generated by the fixed winding 10 can power the excitation winding 20.

The fixed winding 10 is connected to an AC/DC converter 11.

The excitation winding 20 comprises a DC/DC converter 21 or a DC/AC converter.

The rotating winding 30 is arranged on the low-pressure shaft of the turbomachine.

The rotating winding 30 is connected via an electrical power network 3 to a six-diode rotating rectifier 31.

The electrical power network 3 is configured to circulate an electric current with a power greater than or equal to 10 kW and less than or equal to 50 kW so as to power at least one electrical device F1 of the rotating part Pt, which may be for example a device for controlling a pitch of the blades of a fan, fan blade small-pitch protection devices, devices for de-icing a cone or the fan blades.

When the electric machine is operating in a motor mode, the fixed winding 10 is an inductor of the machine, i.e., its function is to induce an electromagnetic field in the rotating winding 30 positioned on the rotating part Pt. For this purpose, the fixed winding 10 is electrically powered, in particular by a three-phase current via the general electrical network 4. An electromagnetic field created by the fixed winding 10 induces an electromagnetic field in the rotating winding 30, thereby driving in rotation the rotating part Pt. The rotating winding 30 is therefore an armature of the machine.

The motor mode of the electric machine can be used when starting the turbomachine 50 or during a maintenance operation requiring a rotation of the rotating part Pt of the turbomachine 50 or even to inject mechanical torque onto a shaft of the turbomachine 50 to which the electric machine is coupled during any flight phase of the aircraft.

When the electric machine is operating in a generator mode, the axis of rotation is driven in rotation by the combustion chamber 54B. The rotating winding 30 is then both an armature and an inductor of the machine. Indeed, on the one hand, it is excited by the excitation winding 20 so that it produces a three-phase electric current in the rotating part Pt, and on the other hand, it induces an electromagnetic field in the fixed winding 10 positioned on the fixed part Pf so that the fixed winding 10 generates a three-phase electric current in the fixed part Pf. The rotating winding 30 delivers a variable voltage whose effective value and frequency vary with a supply voltage of the excitation winding 20.

In the generator mode, the rotating winding 30 induces an electromagnetic field in the fixed winding 10 positioned on the fixed part Pf so that the fixed winding 10 generates a three-phase electric current in the fixed part Pf. This electric current can then power the excitation winding 20 of the electric machine. This is known as self-powering. The frequency of the voltage of the electric current generated by the fixed winding 10 then depends on a rotational speed of the rotating part Pt.

The electric current generated by the fixed winding 10 or the rotating winding 30 is a sinusoidal alternating current.

The electric machine therefore has several functions depending on whether it operates in motor mode or generator mode.

Finally, the turbomachine 50 may comprise a mechanical element for separating and disconnecting the electric machine M1 from a shaft A of the turbomachine 50. For example, the mechanical element for separating and disconnecting the electric machine is positioned in the rotating part of the turbomachine 50.

Indeed, in the event of an electrical failure of the electric machine M1 or the electrical power network 3, it is desirable to have an element that allows the electric machine M1 to be mechanically disconnected.

The mechanical separation element can be a dog clutch.

Although the present disclosure has been described with reference to specific variations, it is obvious that modifications and changes can be made to these examples without departing from the general scope of the present disclosure as defined by the claims. In particular, individual features of the various illustrated/mentioned variations can be combined in additional variations. Therefore, the description and drawings should be considered in an illustrative rather than restrictive sense.

It is also obvious that all the features described with reference to a method are transposable, alone or in combination, to a device, and conversely, all the features described with reference to a device are transposable, alone or in combination, to a method.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A turbomachine for an aircraft, the turbomachine extending along an axis of rotation and comprising at least:
a rotating part rotating about the axis of rotation,
a fixed part fixed in rotation about the axis of rotation relative to the rotating part, the fixed part comprising a fan casing,
an electric machine adapted to operate in generator mode,
wherein the electric machine comprises at least one fixed winding and one excitation winding, which are positioned on the fixed part of the turbomachine, and at least one rotating winding positioned on the rotating part of the turbomachine, the at least one fixed winding, the one excitation winding and the at least one rotating winding being arranged radially about the axis of rotation,
the turbomachine also comprising at least one electrical power network positioned in the rotating part, the at least one electrical power network being connected to the at least one rotating winding, the at least one electrical power network being configured to power at least one electrical device of the turbomachine which is positioned on the rotating part.

2. The turbomachine according to claim 1, wherein the at least one rotating winding is positioned on a low-pressure shaft of the turbomachine.

3. The turbomachine according to claim 1, wherein the at least one electrical device of the turbomachine positioned in the rotating part is a device for controlling a pitch of fan blades, fan blade small-pitch protection devices, de-icing devices for a cone or the fan blades.

4. The turbomachine according to claim 1, wherein the electric machine is a wound-rotor machine.

5. The turbomachine according to claim 1, wherein the at least one fixed winding and the one excitation winding are electrically connected so that an electric supply current generated by the at least one fixed winding can power the one excitation winding.

6. The turbomachine according to claim 1, wherein the one excitation winding comprises a DC/DC converter or a DC/AC converter.

7. The turbomachine according to claim 1, comprising a mechanical element for separating and disconnecting the electric machine from a shaft (A) of the turbomachine.

8. An aircraft comprising the turbomachine according to claim 1.
